(19) United States
(12) Patent Application Publication
(10) Pub. No.: US 2023/0342594 A1
(43) Pub. Date: Oct. 26, 2023

(54) ARTIFICIAL INTELLIGENCE BASED SYSTEM AND METHOD FOR RECOGNITION OF DIMENSIONAL INFORMATION WITHIN ENGINEERING DRAWINGS

(71) Applicant: AI RANDOMTREES LLC, Houston, TX (US)

(72) Inventors: Gautam Komminani, New Meadows, ID (US); Swathi Yanture, Hyderabad (IN)

(21) Appl. No.: 17/727,871

(22) Filed: Apr. 25, 2022

(51) Int. Cl. G06N 3/04; G06N 3/08; G06V 30/422; G06V 30/413; G06V 30/19; G06V 10/82

(52) U.S. Cl. CPC G06N 3/0481; G06N 3/08; G06V 30/422; G06V 30/413; G06V 30/19173; G06V 30/19147; G06V 10/82

(57) ABSTRACT

An AI-based system and method for recognition of dimensional information within engineering drawings is disclosed. The AI-based method includes receiving one or more engineering drawings from one or more user devices and detecting one or more objects in the one or more engineering drawings. The AI-based method further includes identifying a focus object from the one or more objects and detecting a central line and one or more texts of the focus object. Further, the AI-based method includes creating a graph and classifying one or more texts into a predefined set of classes by applying the graph onto a trained dimension recognition based deep reinforcement learning model. The AI-based method determining dimensional information associated with the one or more engineering drawings and outputting the dimensional information associated with the one or more engineering drawings on user interface screen of the one or more user devices.

### FIELD OF INVENTION

Embodiments of the present disclosure relate to Artificial Intelligence (AI) based systems and more particularly relates to an AI-based system and method for recognition of dimensional information within engineering drawings.

### BACKGROUND

Generally, engineering drawings are used to capture geometric measurements of a product or a component. The engineering drawings are systematically drawn using few predefined sets of standards. Further, the engineering drawings are very important in the manufacturing industries. A principal determinant of quality is conformity of geometrical dimensions of the product, or the component as manufactured to those of the part as specified in the engineering drawings. Usually, inspecting the engineering drawings requires exhaustive visual examination by subject matter experts, and is slow, error-prone, and expensive in terms of human labor costs. Further, inspecting the engineering diagrams is a challenging task because engineering schemes and plans generally have very loose layouts and there is a huge variety of such engineering schemes and plans.

Conventionally, there are multiple systems for recognition of dimensional information within the engineering drawings. However, the conventional systems are based solely on computer vision and Natural Language Processing (NLP) techniques. Thus, the conventional systems have difficulty coping with the multitude of dimensions on an engineering drawing. Further, the conventional systems extract all dimensions on the engineering drawing using Optical Character Recognition (OCR) or NLP without considering nuances in the dimensions on the engineering drawings and differentiating the dimensions into proper categories. The conventional systems also perform poorly on previously unseen engineering drawings.

Hence, there is a need for an improved AI-based system and method for recognition of the dimensional information within the engineering drawings, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an Artificial Intelligence (AI) based computing system for recognition of dimensional information within engineering drawings is disclosed. The AI-based computing system includes one or more hardware processors and a memory coupled to the one or more hardware processors. The memory includes a plurality of modules in the form of programmable instructions executable by the one or more hardware processors. The plurality of modules include a data receiver module configured to receive one or more engineering drawings from one or more user devices. The one or more engineering drawings include images, Portable Document Format (PDF), handwritten papers and scanned documents. The plurality of modules also include an object detection module configured to detect one or more objects in the received one or more engineering drawings by using an object detection model. The plurality of modules includes an object identification module configured to identify a focus object from the detected one or more objects by using an attention-based model with its softmax layer. The focus object is an engineering drawing including one or more required measurements. Further, the plurality of modules includes a line detection module configured to detect a central line and the one or more texts of the identified focus object by using the object detection model. The plurality of modules also include a graph creation module configured to create a graph based on one or more texts in the identified focus object and the detected central line of the identified focus object by using the graphical neural network model. The detected central line is a root node and the one or more texts are one or more child nodes. Each of the one or more child nodes and the root node has a normalized distance. The normalized distance between each of the one or more child nodes and the root node are a set of edges of the created graph. The created graph represents information associated with the one or more texts and relative information of the one or more texts with the central line. Furthermore, the plurality of modules include a text classifying module configured to classify the one or more texts into a predefined set of classes by applying the created graph onto a trained dimension recognition based deep reinforcement learning model. The plurality of modules further include a dimensional information determination module configured to determine dimensional information associated with the one or more engineering drawings based on result of the classification. Further, the plurality of modules include a data output module configured to output the determined dimensional information associated with the one or more engineering drawings on user interface screen of the one or more user devices.

In accordance with another embodiment of the present disclosure, an Artificial Intelligence (AI) based method for recognition of dimensional information within engineering drawings is disclosed. The AI-based method includes receiving one or more engineering drawings from one or more user devices. The one or more engineering drawings include images, Portable Document Format (PDF), handwritten papers and scanned documents. The AI-based method also includes detecting one or more objects in the received one or more engineering drawings by using an object detection model. The AI-based method further includes identifying a focus object from the detected one or more objects by using an attention-based model with its softmax layer. The focus object is an engineering drawing including one or more required measurements. Further, the AI-based method includes detecting a central line and one or more texts of the identified focus object by using the object detection model. Also, the AI-based method includes creating a graph based on the one or more texts in the identified focus object and the detected central line of the identified focus object by using the graphical neural network model. The detected central line is a root node and the one or more texts are one or more child nodes. Each of the one or more child nodes and the root node has a normalized distance. The normalized distance between each of the one or more child nodes and the root node are a set of edges of the created graph. The created graph represents information associated with the one or more texts and relative information of the one or more texts with the central line. Furthermore, the AI-based method includes classifying the one or more texts into a predefined set of classes by applying the created graph onto a trained dimension recognition based deep reinforcement learning model. The AI-based method also includes determining dimensional information associated with the one or more engineering drawings based on result of the classification. Further, the AI-based method includes outputting the determined dimensional information associated with the one or more engineering drawings on user interface screen of the one or more user devices.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment for recognition of dimensional information within engineering drawings, in accordance with an embodiment of the present disclosure;

FIG. 2A is a block diagram illustrating an exemplary Artificial Intelligence (AI) based computing system for recognition of the dimensional information within the engineering drawings, in accordance with an embodiment of the present disclosure;

FIG. 2B is a block diagram illustrating an exemplary process of detecting one or more objects in one or more engineering drawings, in accordance with an embodiment of the present disclosure;

FIG. 2C is a block diagram illustrating an exemplary process of identifying a focus object from the one or more objects in the engineering drawings, in accordance with an embodiment of the present disclosure;

FIG. 2D is a block diagram illustrating an exemplary process of determining a set of central lines in the engineering drawings, in accordance with an embodiment of the present disclosure;

FIG. 2E is a block diagram illustrating an exemplary process of detecting a central line in the engineering drawings, in accordance with an embodiment of the present disclosure;

FIG. 2F is a schematic representation of an exemplary graph created based on the focus object and the central line in the engineering drawings, in accordance with an embodiment of the present disclosure;

FIG. 2G illustrates a Graph Convolutional Network (GCN) layer computing mean of one or more neighbor child node's feature vectors, in accordance with an embodiment of the present disclosure;

FIG. 2H illustrates reinforcement learning environment with its actions, states and feedbacks, in accordance with an embodiment of the present disclosure;

FIG. 2I illustrates reinforcement learning environment with its actions, states and feedbacks, in accordance with another embodiment of the present disclosure;

FIG. 3 is a flow chart illustrating an exemplary operation of the AI-based computing system for recognition of the dimensional information within the engineering drawings, in accordance with an embodiment of the present disclosure;

FIGS. 4A-4D illustrates exemplary pictorial depiction of engineering drawings, in accordance with an embodiment of the present disclosure; and

FIG. 5 is a process flow diagram illustrating an exemplary AI-based method for recognition of the dimensional information within the engineering drawings, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises” a″ does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

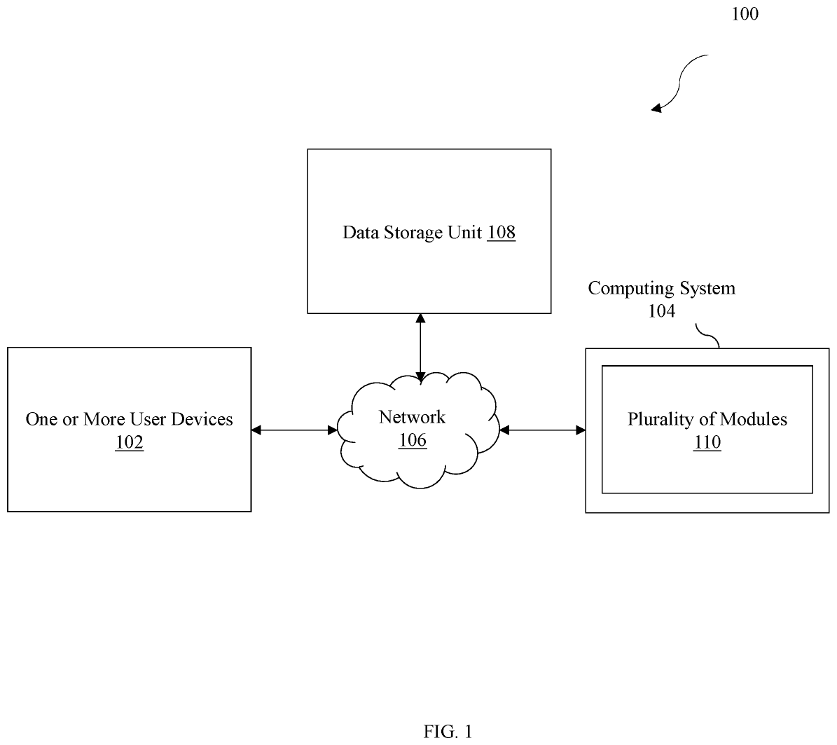

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 is a block diagram illustrating an exemplary computing environment 100 for recognition of dimensional information within engineering drawings, in accordance with an embodiment of the present disclosure. According to FIG. 1, the computing environment 100 includes one or more user devices 102 associated with one or more users communicatively coupled to an Artificial Intelligence (AI) based computing system 104 via a network 106. The one or more user devices 102 are used by the one or more users to provide one or more engineering drawings to the AI-based computing system 104. In an exemplary embodiment the present disclosure, the one or more engineering drawings include images, Portable Document Format (PDF), handwritten papers, scanned documents and the like. In an embodiment of the present disclosure, the one or more engineering drawings may also be received by the AI-based computing system 104 from a data storage unit 108 associated with the one or more users. In an exemplary embodiment of the present disclosure, the data storage unit 108 may be a cloud server, a remote server, any storage device and the like. The one or more user devices 102 may also be used by the one or more users to receive dimensional information associated with the one or more engineering drawings from the AI-based computing system 104. In an exemplary embodiment of the present disclosure, the one or more user devices 102 may include a laptop computer, desktop computer, tablet computer, smartphone, wearable device, smart watch, a digital camera and the like. Further, the network 106 may be internet or any other wireless network. The AI-based computing system 104 may be hosted on a central server, such as cloud server or a remote server.

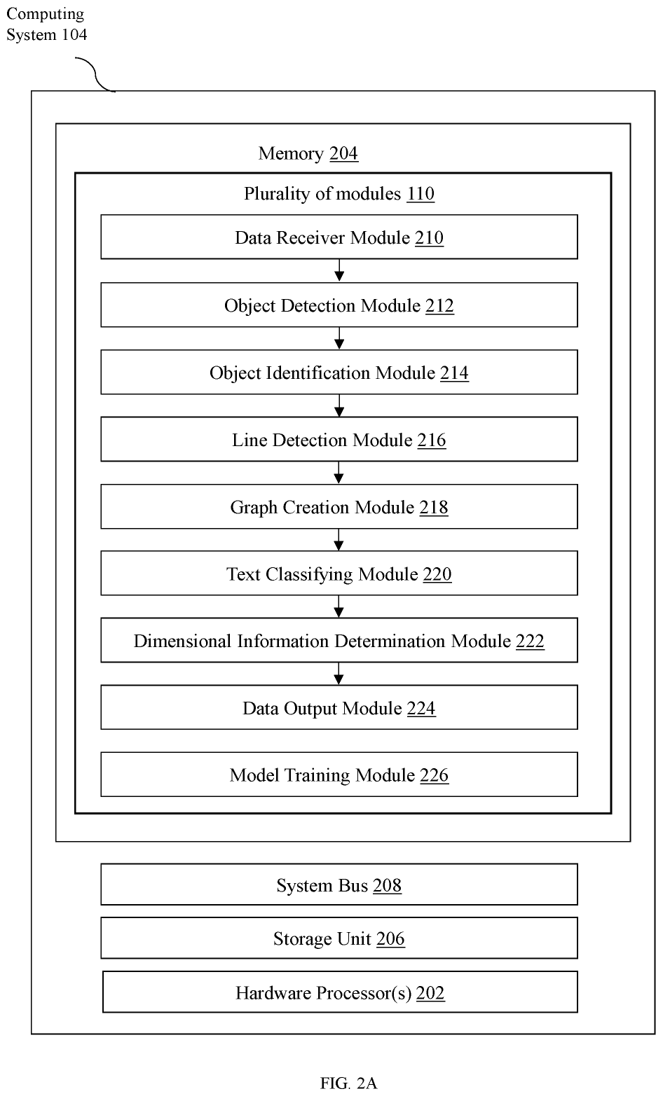

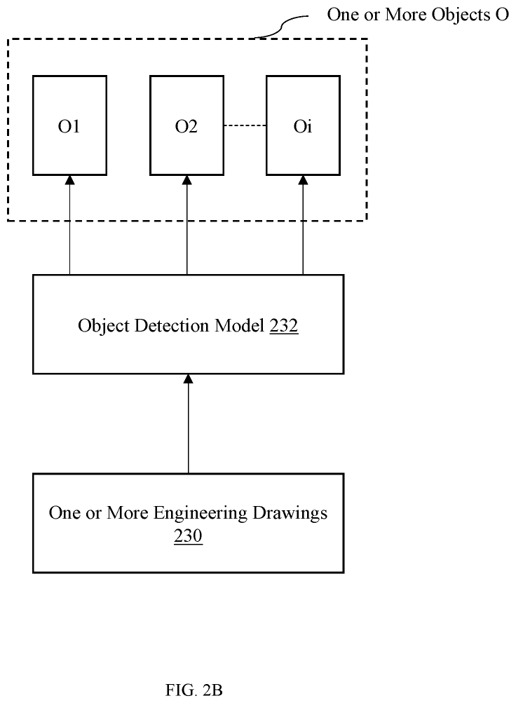

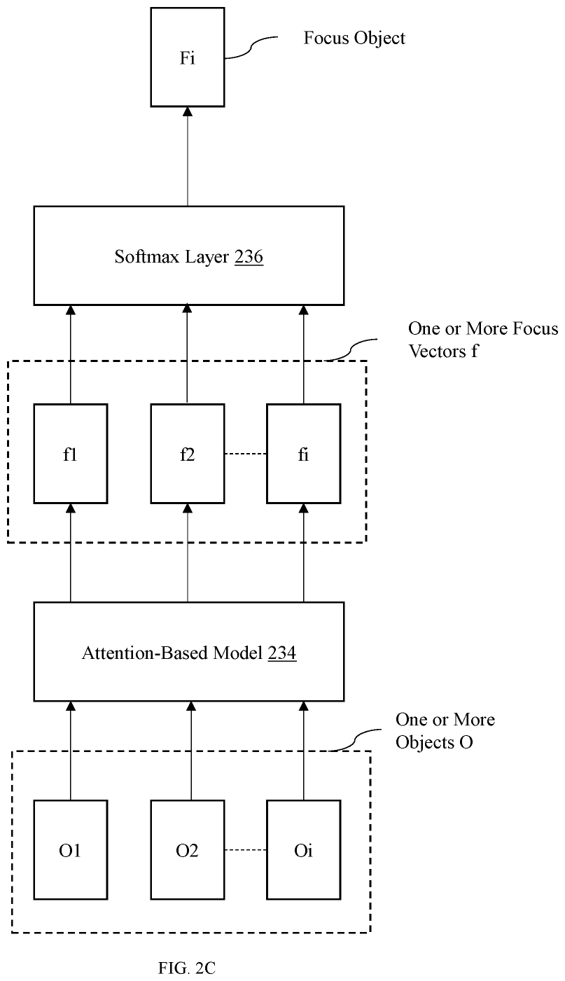

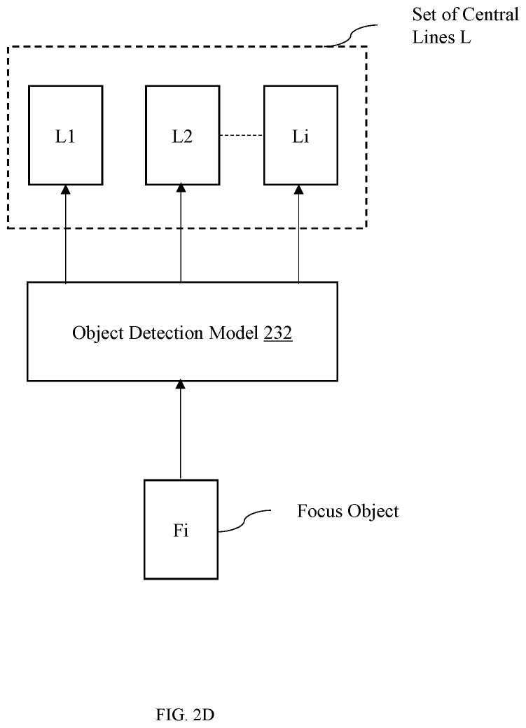

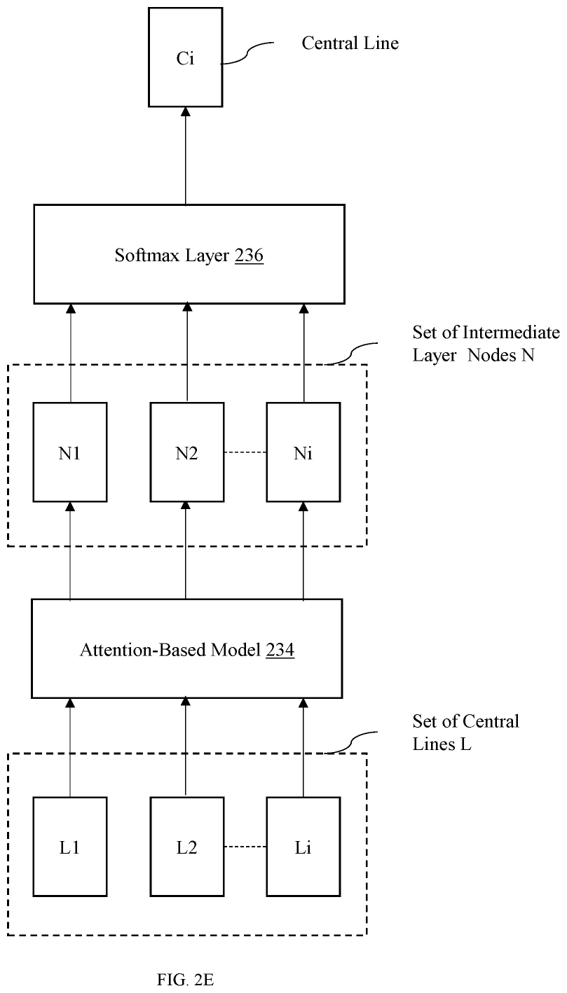

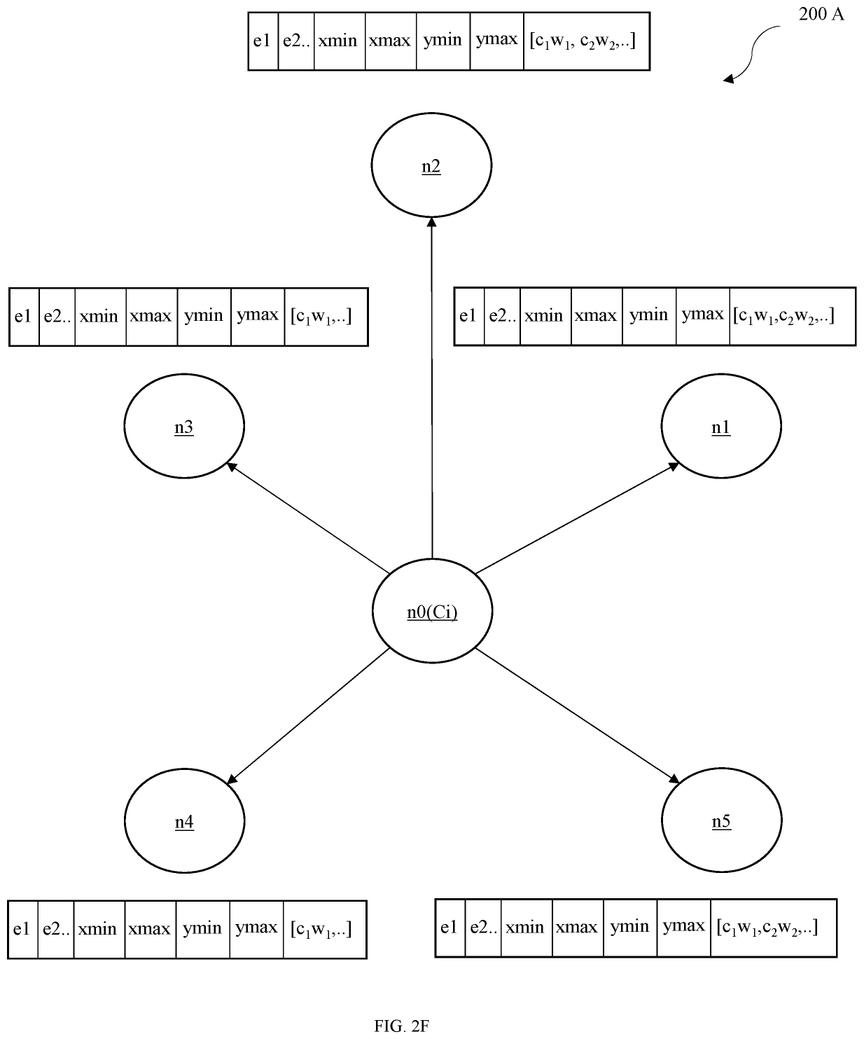

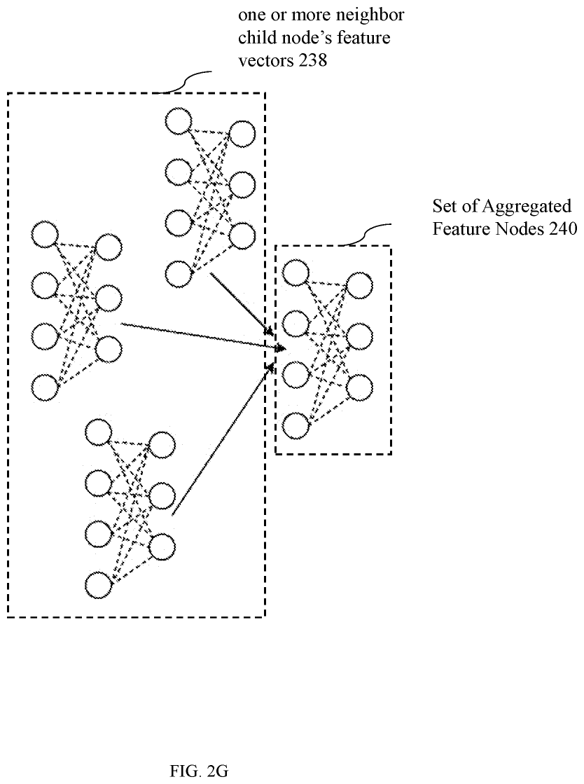

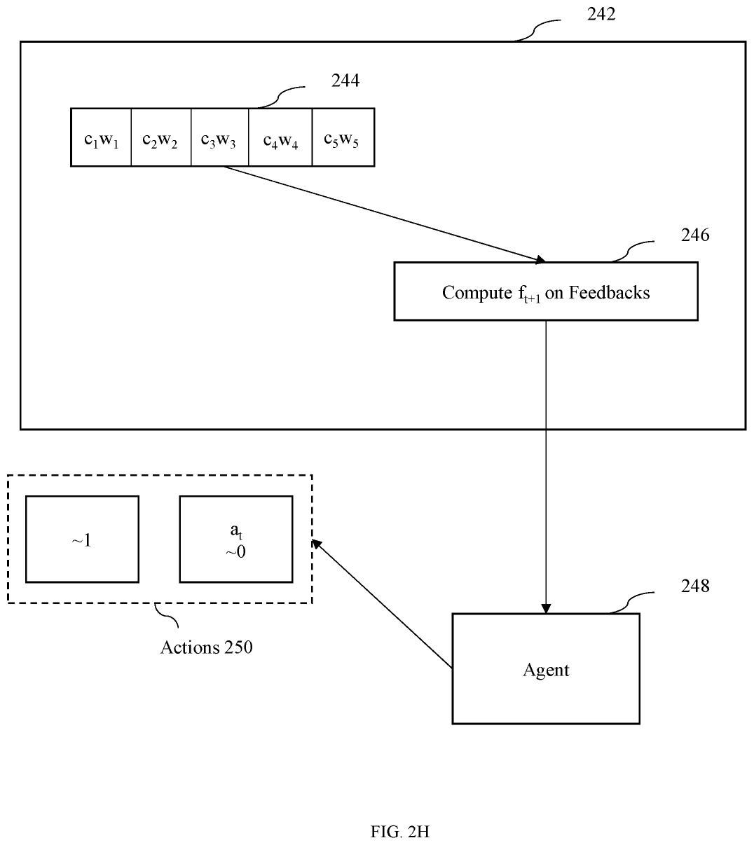

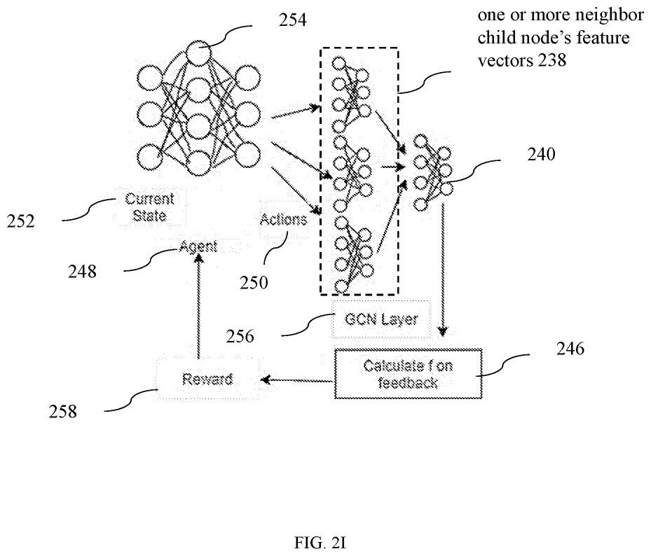

Further, the one or more user devices 102 include a local browser, a mobile application or a combination thereof. Furthermore, the one or more users may use a web application via the local browser, the mobile application or a combination thereof to communicate with the AI-based computing system 104. In an embodiment of the present disclosure, the AI-based computing system 104 includes a plurality of modules 110. Details on the plurality of modules 110 have been elaborated in subsequent paragraphs of the present description with reference to FIG. 2A.

In an embodiment of the present disclosure, the AI-based computing system 104 is configured to receive the one or more engineering drawings from the one or more user devices 102 associated with the one or more users. Further, the AI-based computing system 104 detects one or more objects in the received one or more engineering drawings by using an object detection model. The AI-based computing system 104 identifies a focus object from the detected one or more objects by using an attention-based model with its softmax layer. In an embodiment of the present disclosure, the focus object is an engineering drawing including one or more required measurements. Furthermore, the AI-based computing system 104 detects a central line and one or more texts of the identified focus object by using the object detection model. The AI-based computing system 104 creates a graph based on the one or more texts in the identified focus object and the detected central line of the identified focus object by using the graphical neural network model. In an embodiment of the present disclosure, the detected central line is a root node, the one or more texts are one or more child nodes and normalized distance between each of the one or more child nodes and the root node are a set of edges of the created graph. The created graph represents information associated with the one or more texts and relative information of the one or more texts with the central line. The AI-based computing system 104 also classifies the one or more texts into a predefined set of classes by applying the created graph onto a trained dimension recognition based deep reinforcement learning model. Further, the AI-based computing system 104 determines dimensional information associated with the one or more engineering drawings based on result of the classification. The AI-based computing system 104 outputs the determined dimensional information associated with the one or more engineering drawings on user interface screen of the one or more user devices 102.

FIG. 2A is a block diagram illustrating an exemplary AI-based computing system 104 for recognition of the dimensional information within the engineering drawings, in accordance with an embodiment of the present disclosure. FIG. 2B is a block diagram illustrating an exemplary process of detecting one or more objects in one or more engineering drawings, in accordance with an embodiment of the present disclosure. Further, FIG. 2C is a block diagram illustrating an exemplary process of identifying a focus object from the one or more objects in the engineering drawings, in accordance with an embodiment of the present disclosure. FIG. 2D is a block diagram illustrating an exemplary process of determining a set of central lines in the engineering drawings, in accordance with an embodiment of the present disclosure. Furthermore, FIG. 2E is a block diagram illustrating an exemplary process of detecting a central line in the engineering drawings, in accordance with an embodiment of the present disclosure. FIG. 2F is a schematic representation of an exemplary graph 200 A, in accordance with an embodiment of the present disclosure. Further, FIG. 2G illustrates a Graph Convolutional Network (GCN) layer computing mean of one or more neighbor child node's feature vectors, in accordance with an embodiment of the present disclosure. FIG. 2H illustrates reinforcement learning environment with its actions, states and feedbacks, in accordance with an embodiment of the present disclosure. Furthermore, FIG. 2I illustrates reinforcement learning environment with its actions, states and feedbacks, in accordance with another embodiment of the present disclosure. For the sake of brevity, FIGS. 2A-2I have been explained together.

Further, the AI-based computing system 104 includes one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 110 in the form of programmable instructions executable by the one or more hardware processors 202. Further, the plurality of modules 110 includes a data receiver module 210, an object detection module 212, an object identification module 214, a line detection module 216, a graph creation module 218, a text classifying module 220, a dimensional information determination module 222, a data output module 224 and a model training module 226.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 110 stored in the form of machine-readable instructions on any of the above-mentioned storage media and may be in communication with and executed by the one or more hardware processors 202.

The storage unit 206 may be a cloud storage. The storage unit 206 may store the one or more engineering drawings, the one or more objects and the central line. The storage unit 206 may also store the created graph, the one or more texts, the predefined set of classes, the dimensional information, centerline information associated with the central line and adjacent field information.

The data receiver module 210 is configured to receive the one or more engineering drawings 230 from the one or more user devices 102. In an embodiment of the present disclosure, the one or more engineering drawings 230 include images, Portable Document Format (PDF), handwritten papers, scanned documents and the like. For example, the one or more engineering drawings 230 may be complex scanned engineering drawings of oil and gas parts. In an exemplary embodiment of the present disclosure, the one or more user devices 102 may include a laptop computer, desktop computer, tablet computer, smartphone, wearable device, smart watch, a digital camera and the like.

The object detection module 212 is configured to detect the one or more objects O1, O2 . . . Oi in the received one or more engineering drawings 230 by using the object detection model 232. For the sake of present description, the one or more objects O1, O2 . . . Oi have been represented as ‘O’. For example, the object detection model 232 may be YOLO V3. In an embodiment of the present disclosure, the one or more objects ‘O’ in the one or more engineering drawings 230 may represent multiple views of a single product. Therefore, it is important to identify a view from the multiple views and set boundaries where one or more required measurements are present. As shown in FIG. 2B, the object detection model 232 is applied on the one or more engineering drawings 230 to detect the one or more objects ‘O’ in the one or more engineering drawings 230. The object detection model 232 is a pretrained model for detecting the one or more objects ‘O’. In an embodiment of the present disclosure, the object detection model 232 detects all available engineering diagrams in the one or more engineering drawings 230 as individual objects.

The object identification module 214 is configured to identify the focus object ‘Fᵢ’ from the detected one or more objects ‘O’ by using the attention-based model 234 with its softmax layer 236. The attention-based model 234 corresponds to “attention is all you need” mechanism. This mechanism employs similar pixels in training and prediction ignoring dissimilar pixels. In an embodiment of the present disclosure, attention function is computed on a set of queries simultaneously, packed together into a matrix Q. The keys and values are also packed together into matrices K and V. Further, matrix of outputs is computed as:

Attention(Q,K,V)=softmax(Transpose(QK)/√dk)V equation (1)

In an embodiment of the present disclosure, the focus object is an engineering drawing including the one or more required measurements. In an embodiment of the present disclosure, the attention-based model 234 is location-based attention layer. The attention-based model 234, the softmax layer 236 and a set of intermediate layer nodes N1, N2 . . . Ni are used to identify the focus object ‘Fi’. For the sake of present description, the one or more objects N1, N2 . . . Ni have been represented as ‘N’. In an exemplary embodiment of the present disclosure, the one or more required measurements include minimum inner diameter, maximum outer diameter, maximum length, inner radius, outer radius of each of the one or more objects within the one or more engineering diagrams and the like. As shown in FIG. 2C, the attention-based model 234 is applied on the detected one or more objects ‘O’ to compute one or more focus vectors f₁, f₂ . . . fₙ including a weight ‘aᵢ’ for each object in the detected one or more objects ‘O’, representing importance of each of the one or more objects ‘O’. For the sake of present description, the one or more focus vectors f₁, f₂ . . . fₙ have been represented as f. Further, the softmax layer 236 is applied on the one or more focus vectors ‘f’ to identify the focus object ‘Fᵢ’. In an embodiment of the present disclosure, the focus object ‘Fᵢ’ is computed as:

Focus object (Fi)=Σweight (ai) one or more objects (O) equation (2)

The line detection module 216 is configured to detect the central line ‘Cᵢ’ and one or more texts of the identified focus object ‘Fᵢ’ by using the object detection model 232. In detecting the central line ‘Cᵢ’ of the identified focus object ‘Fᵢ’ by using the object detection model 232, the line detection module 216 detects a plurality of lines from the identified focus object ‘Fᵢ’ by using the object detection model 232. In an exemplary embodiment of the present disclosure, the plurality of lines include vertical lines, central lines, horizontal lines and the like. Further, the line detection module 216 determines a set of central lines L₁, L₂ . . . Lₙ among the detected plurality of lines based on prestored line information defined within the object detection model 232. For the sake of present description, the set of central lines L₁, L₂ . . . Lₙ have been represented as ‘L’. The line detection module 216 identifies the central line ‘Cᵢ’ from the determined set of central lines by using the attention-based model 234 with its softmax layer 236. As shown in FIG. 2D, the object detection model 232 is applied on the focus object ‘Fᵢ’ to determine the set of central lines L or detect the central line ‘Cᵢ’ Furthermore, as shown in FIG. 2E, the attention-based model 234 and the softmax layer 236 is applied on the set of lines ‘L’ to identify a single central line ‘Cᵢ’. In an embodiment of the present disclosure, there is only a single central line ‘Cᵢ’ in a single view. Thus, the single central line ‘Cᵢ’ is identified from the set of lines ‘L’. In an embodiment of the present disclosure, the attention-based model 234 is an attention based focus vector.

The graph creation module 218 is configured to create the graph based on the one or more texts in the identified focus object ‘Fᵢ’ and the detected central line ‘Cᵢ’ of the identified focus object ‘Fᵢ’ by using the graphical neural network model. In an embodiment of the present disclosure, the detected central line ‘Cᵢ’ is a root node and the one or more texts are one or more child nodes. In an embodiment of the present disclosure, each of the one or more child nodes and the root node has a normalized distance. The normalized distance between each of the one or more child nodes and the root node are a set of edges of the created graph. The normalized distance between each of the one or more child nodes and the root node includes the root node, the one or more child nodes and weight associated with the normalized distance. In an embodiment of the present disclosure, a function ‘Mij’ is used to compute the normalized distance between each of the one or more child nodes and the root node. In an exemplary embodiment of the present disclosure, the equation to compute the function Mij is:

Mij=fc(Euclidean distance(ni,nj),w) equation (3)

In an embodiment of the present disclosure, ‘ni’ and ‘nj’ are the root node and the one or more child nodes respectively and w is the weight associated with the one or more child nodes. Further, aggregating the node level ‘Mij’ after updating state from a trained dimension recognition based deep reinforcement learning model mat act as its average weight. Further, the created graph represents information associated with the one or more texts and relative information of the one or more texts with the central line ‘Cᵢ’. In an embodiment of the present disclosure, each of the one or more child nodes includes numerical representation of the one or more texts, location of the one or more texts and the predefined set of classes multiplied by one or more weights of the predefined set of classes. For example, a child node includes [e1, e2, e3, e4 . . . en, xmin, ymin, xmax, ymax, c₁w₁, c₂w₂, c₃w₃], where e1, e2, e3, e4 . . . en are numerical representation of the one or more texts, xmin, ymin, xmax and ymax are location of the one or more texts and c₁w₁, c₂w₂, c₃w₃ are the predefined set of classes multiplied by one or more weights of the predefined set of classes. In an embodiment of the present disclosure, the weight w in the function Mij determines if a child node from the one or more child nodes is useful and weights w1, w2 and w3 in the one or more child nodes determine classes of the one or more child nodes.

In an embodiment of the present disclosure, an exemplary graph 200 A is shown in FIG. 2F with a root node nO (Cᵢ), five child nodes n1, n2, n3, n4 and n5 and five edges MO1, MO2, MO3, MO4 and MO5. In an embodiment of the present disclosure, first child node ‘n1’ includes [e1, e2, xmin, xmax, ymin, ymax, c₁w₁, c₂w₂] and first edge MO1 may be represented as:

MO1=fc(Euclidean distance(n0,n1),w) equation (4)

Further, second child node ‘n2’ includes [e1, e2, xmin, xmax, ymin, ymax, c₁w₁, c₂w₂] and second edge MO2 may be represented as:

MO2=fc(Euclidean distance(n0,n2),w) equation (5)

Furthermore, third child node ‘n3’ includes [e1, e2, xmin, xmax, ymin, ymax, c₁w₁] and third edge MO3 may be represented as:

MO3=fc(Euclidean distance(n0,n3),w) equation (6)

Further, fourth child node ‘n4’ includes [e1, e2, xmin, xmax, ymin, ymax, c₁w₁] and fourth edge MO4 may be represented as:

MO4=fc(Euclidean distance(n0,n4),w) equation (7)

Similarly, fifth child node ‘n5’ includes [e1, e2, xmin, xmax, ymin, ymax, c₁w₁, c₂w₂] and fifth edge MO5 may be represented as:

MO5=fc(Euclideandistance(n0,n5),w) equation(8)

Further, in creating the graph based on the one or more texts in the identified focus object ‘Fᵢ’ and the detected central line ‘Cᵢ’ of the identified focus object ‘Fᵢ’ by using a graphical neural network model, the graph creation module 218 computes hidden state of each of the one or more child nodes by computing average of one or more feature vectors from one or more neighboring nodes 238. In an embodiment of the present disclosure, the Graph Convolutional Network (GCN) is used to leverage graph adjacency information. Furthermore, the graph creation module 218 combines plurality of GCN layers together based on the computed hidden state of each of the one or more child nodes. The graph creation module 218 receives centerline information associated with the central line ‘Cᵢ’ and adjacent field information by each of the one or more child node from one or more farther child nodes by using the combined plurality of GCN layers. In an embodiment of the present disclosure, the one or more farther child nodes are farther from respective node. For example, if there are 4 nodes, the relative distance from each other can also be leveraged. Further, the graph creation module 218 transmits the centerline information and the adjacent field information to one or more last GCN layers by using the combined plurality of GCN layers. In an exemplary embodiment of the present disclosure, transmission of the centerline information and the adjacent field information to one or more last GCN layers is performed by using five GCN layers. In an embodiment of the present disclosure, the GCN layer may be formulated as:

H(l+1)=σ(D−½AD−½)H(l)W(l) equation (9)

A=A˜+IN equation (10)

In an embodiment of the present disclosure, A is adjacency matrix (A^{˜}) of topology graph G plus identity matrix (I_{N}). In an embodiment of the present disclosure, adding the identity matrix (I_{N}) is common in GCN networks. FIG. 2G illustrates a GCN layer computing mean of one or more neighbor child node's feature vectors 238. The GCN layer calculates hidden state of each node by aggregating the one or more neighbor child node's feature vectors 238 from its neighbors. Further, a set of aggregated feature nodes 240 are obtained from result of aggregation. In an embodiment of the present disclosure, five GCN layers are used for calculation of hidden state of each node. Furthermore, each node is the feature vector represented in FIG. 2F.

Dii=ΣjAij equation (11)

In an embodiment of the present disclosure, Dᵢᵢ and W^{l} is a layer-specific trainable weight matrix, echoing with the shared weights in FIG. 2G. Further, σ(·) is an activation function such as:

ReLU(·)·H(l)∈Rn×d equation (12)

In an embodiment of the present disclosure ReLU(·) is the hidden features in the lth layer (n: number of nodes, d: feature dimension).

H0=S equation (13)

In an embodiment of the present disclosure, H⁰ are the input state vectors for actor. In an embodiment of the present disclosure, averaging and smoothing across the one or more child nodes is done to minimize ‘L2’ error.

In an embodiment of the present disclosure, when the focus object ‘Fᵢ’ is identified, the one or more required measurements are drawn relative to the detected central line ‘Cᵢ’. Further, it is important to retain relative information between the one or more required measurements and the central line ‘Cᵢ’. Thus, the object detection model 232 is used to detect the central line ‘Cᵢ’ and the graphical neural network model is used to establish and leverage the relative information where the detected central line ‘Cᵢ’ acts as the root node and the one or more texts act as the one or more child nodes.

The text classifying module 220 is configured to classify the one or more texts into a predefined set of classes by applying the created graph onto a trained dimension recognition based deep reinforcement learning model. In classifying the one or more texts into the predefined set of classes by applying the created graph onto the trained dimension recognition based deep reinforcement learning model, the text classifying module 220 updates weights of each of the one or more child nodes and the set of edges by using the trained dimension recognition based deep reinforcement learning model. Further, the text classifying module 220 classifies the one or more texts into the predefined set of classes based on the updated weights of each of the one or more child nodes by using the trained dimension recognition based deep reinforcement learning model. In an embodiment of the present disclosure, the trained dimension recognition based deep reinforcement learning model includes one or more components including environment, state, actions and reward. In an embodiment of the present disclosure, the environment includes the graph with the root node, the one or more child nodes and weights associated with the set of edges. Further, the state describes class label at each of the one or more child nodes. The actions include selecting one class, such as ‘C_{u,k}’ in each of the one or more child nodes and changing the selected class to a value near 0 or 1. In an exemplary embodiment of the present disclosure, changing the selected class to a value near 0 or 1 results in 3*m actions where m is number of the set of predefined classes. In an embodiment of the present disclosure, the trained dimension recognition based deep reinforcement learning model may assign the value of class ‘C_{u,k}’ between 0.9 to 1.0, such that the class ‘C_{u,k}’ may be multiplied by a classifier's weight. The output of the multiplication may be the classifier's weight. Therefore, the value of class ‘C_{u,k}’ gets high importance to the classifier. In an embodiment of the present disclosure, the trained dimension recognition based deep reinforcement learning model may also assign the value of ‘C_{u,k}’ between 0 to 0.01. In this scenario, the class ‘C_{u,k}’ is neutral and unimportant to a classifier as it will result in 0 when multiplied by the classifier's weight. In an embodiment of the present disclosure, in parallel at each action, a weight is also assigned to the function ‘Mij’ which will result in the usefulness of child node. Further, the reward is given based on how successful the class of each of the one or more child nodes is predicted by the trained dimension recognition based deep reinforcement learning model. In an embodiment of the present disclosure, negative reward is −1 and positive reward may be 1. The total reward of the trained dimension recognition based deep reinforcement learning model is sum of each node predictions. In an embodiment of the present disclosure, the trained dimension recognition based deep reinforcement learning model may perform actions by selecting one class in each of the one or more child nodes, as shown in FIG. 2H. In an embodiment of the present disclosure, environment 242 includes a feature vector 244 upon which an action is performed, and feedback is calculated. At block 246, feedback is computed. Further, agent 248, as shown in FIG. 2H, is a small neural network whose outputs are actions 250 required to be taken on the environment 242. FIG. 2I illustrates reinforcement learning environment with its actions, states and feedbacks. In an embodiment of the present disclosure, the agent 248 updates current state 252. Further, aggregation is performed on GCN layer 256. Furthermore, feedback 246 is calculated on the aggregated result and reward 258 is generated. In an embodiment of the present disclosure, the agent 248 determines next step based on the reward 258.

The dimensional information determination module 222 is configured to determine the dimensional information associated with the one or more engineering drawings 230 based on result of the classification. In determining the dimensional information associated with the one or more engineering drawings 230 based on result of the classification, the dimensional information determination module 222 determines the set of child nodes from the one or more child nodes based on the updated weights of each of the set of edges by using the trained dimension recognition based deep reinforcement learning model. Further, the dimensional information determination module 222 determines the dimensional information associated with the one or more engineering drawings 230 based on classification of the one or more texts into the predefined set of classes and the determined set of child nodes by using the trained dimension recognition based deep reinforcement learning model. In an exemplary embodiment of the present disclosure, the dimensional information includes minimum inner diameter, maximum outer diameter, maximum length, inner radius, outer radius of each of the one or more objects within the one or more engineering diagrams and the like.

In an embodiment of the present disclosure, before using the trained dimension recognition based deep reinforcement learning model, dimension recognition based deep reinforcement learning model is required to be trained. The model training module 226 configured to train the dimension recognition based deep reinforcement learning model. In training the dimension recognition based deep reinforcement learning model, the model training module 226 correlates the focus object Fᵢ, the central line Cᵢ of the focus object Fᵢ and the one or more texts in the focus object Fᵢ. Further, the model training module 226 trains the dimension recognition based deep reinforcement learning model based on result of correlation.

The data output module 224 is configured to output the determined dimensional information associated with the one or more engineering drawings 230 on user interface screen of the one or more user devices 102.

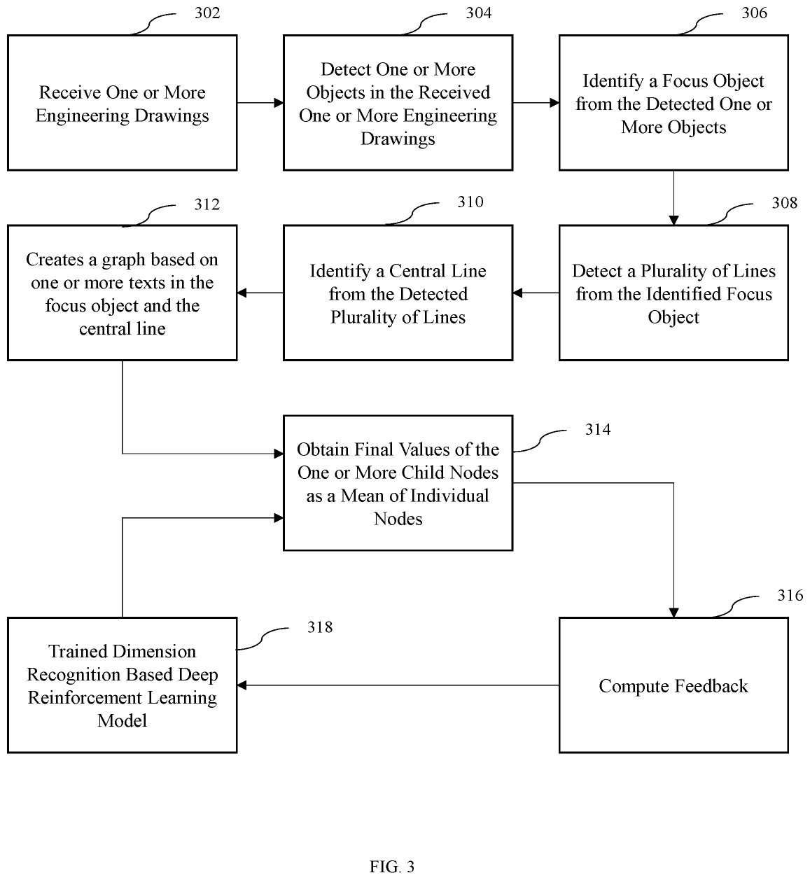

FIG. 3 is a flow chart illustrating an exemplary operation of the AI-based computing system 104 for recognition of the dimensional information within the engineering drawings, in accordance with an embodiment of the present disclosure. At step 302, the AI-based computing system 104 receives one or more engineering drawings 230 from the one or more user devices 102 associated with the one or more users. Further, the AI-based computing system 104 detects the one or more objects ‘O’ in the received one or more engineering drawings 230 by using the object detection model 232, at step 304. The AI-based computing system 104 identifies the focus object ‘Fᵢ’ from the detected one or more objects ‘O’ by using the attention-based model 234 with its softmax layer 236 at step 306. In an embodiment of the present disclosure, the focus object is an engineering drawing including one or more required measurements. Furthermore, at step 308, the AI-based computing system 104 detects the plurality of lines from the identified focus object ‘Fᵢ’ by using the object detection model 232. At step 310, the AI-based computing system 104 identifies the central line ‘Cᵢ’ from the detected plurality of lines by using the attention-based model 234 with its softmax layer 236. At step 312, the AI-based computing system 104 creates the graph based on the one or more texts in the identified focus object ‘Fᵢ’ and the detected central line ‘Cᵢ’ of the identified focus object ‘Fᵢ’ by using the graphical neural network model. In an embodiment of the present disclosure, the detected central line ‘Cᵢ’ is the root node and the one or more texts are the one or more child nodes. In an embodiment of the present disclosure, each of the one or more child nodes and the root node has a normalized distance. The normalized distance between each of the one or more child nodes and the root node are the set of edges of the created graph. Further, at step 314, the AI-based computing system 104 obtains final values of the one or more child nodes as a mean of individual nodes by using the graphical neural network model. At step 316, the AI-based computing system 104 computes feedback associated with the one or more child nodes and at step 318, the AI-based computing system 104 provides the computed feedback to the trained dimension recognition based deep reinforcement learning model. Furthermore, the trained dimension recognition based deep reinforcement learning model performs actions by selecting one class in each of the one or more child nodes and changing the selected class to a value near 0 or 1 to determine the dimensional information.

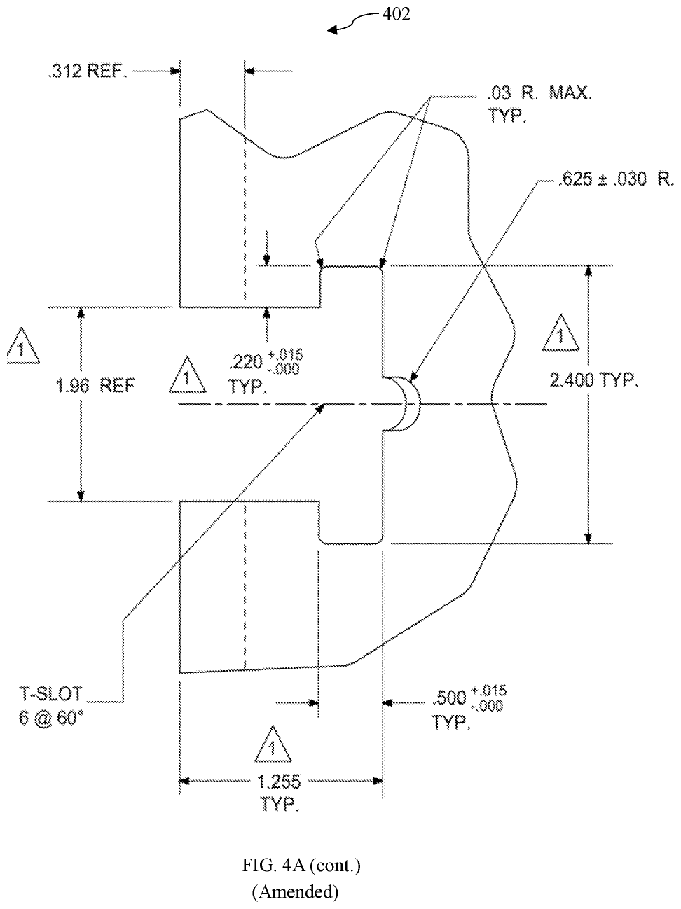

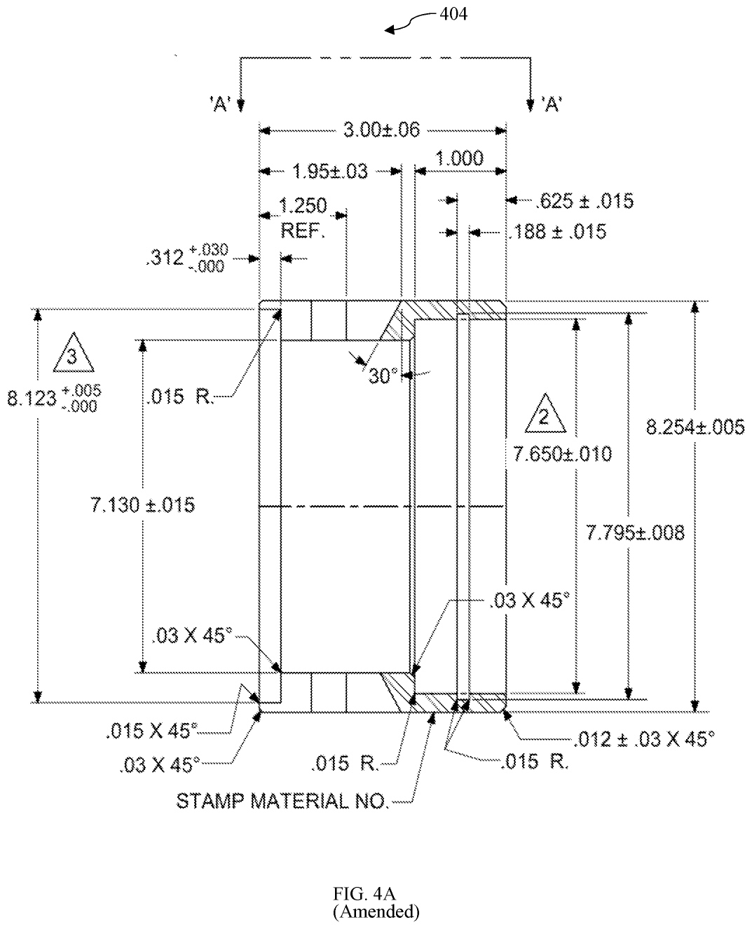

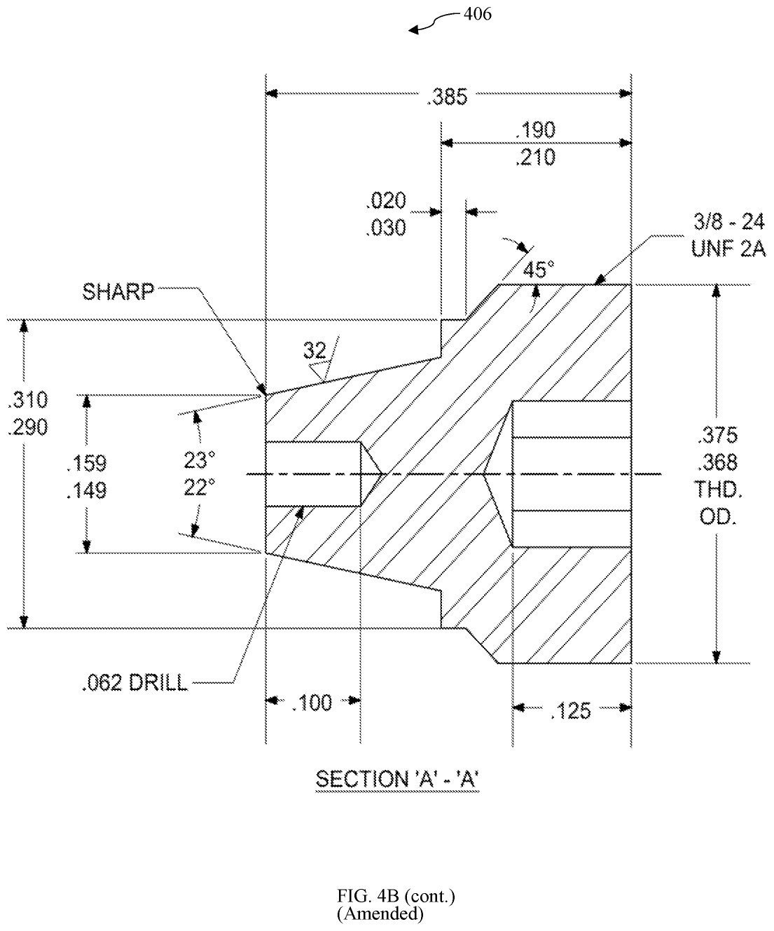

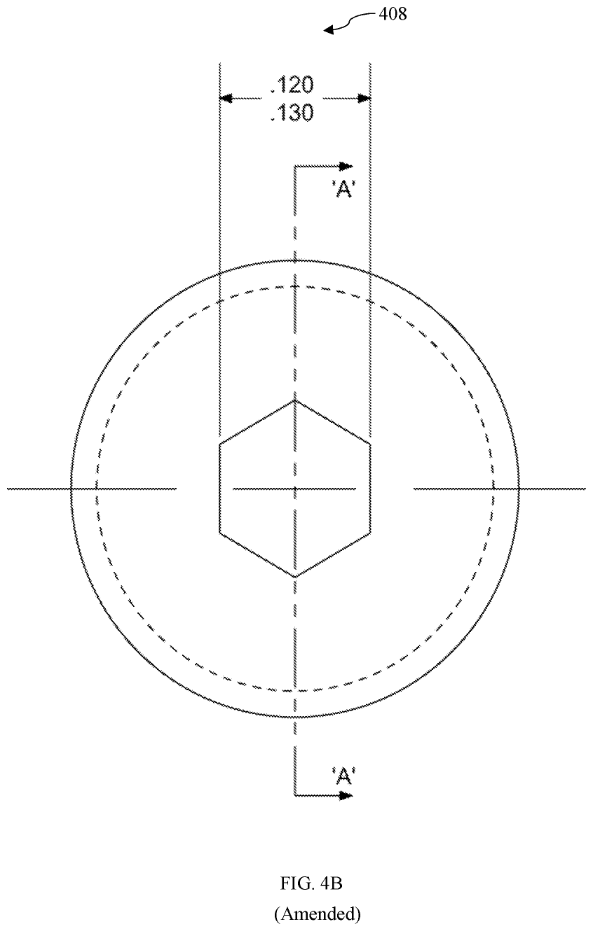

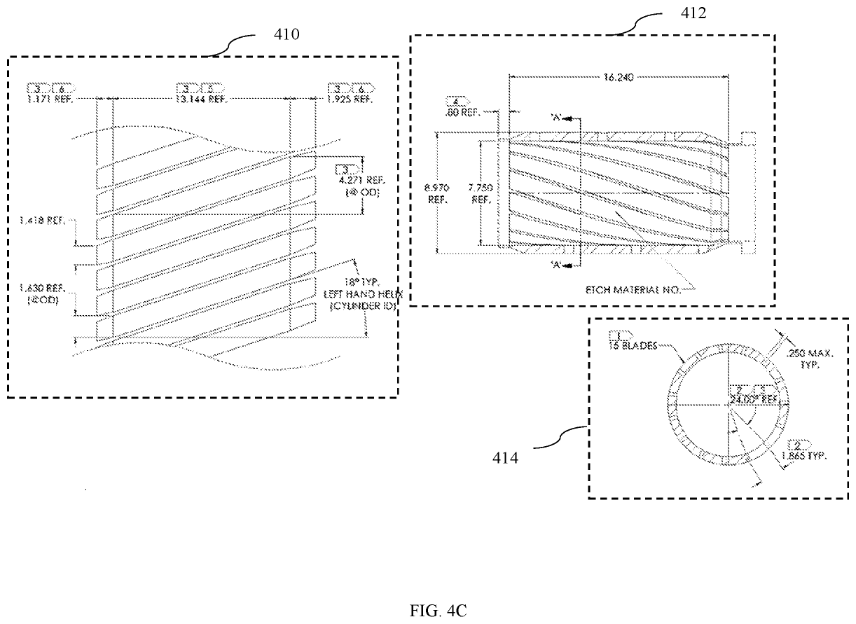

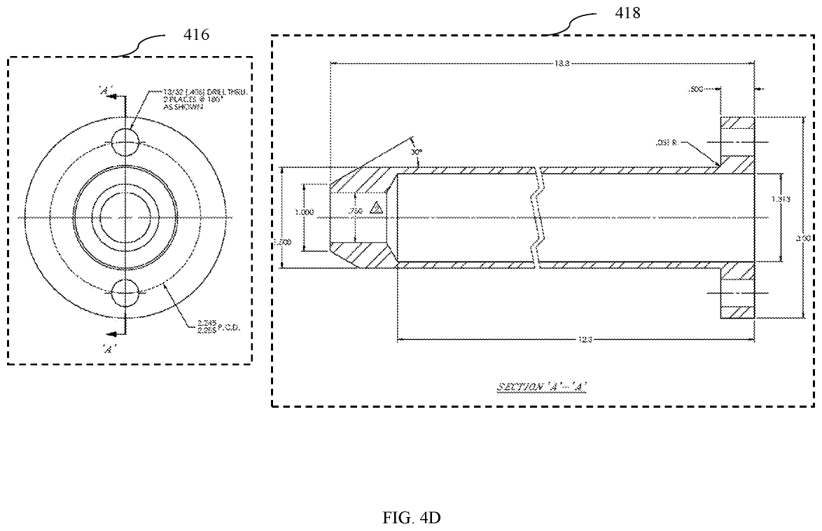

FIGS. 4A-4D illustrates exemplary pictorial depiction of engineering drawings, in accordance with an embodiment of the present disclosure. FIG. 4A depicts a first engineering drawing 402 and a second engineering drawing 404. Further, FIG. 4B depicts a third engineering drawing 406 and a fourth engineering drawing 408. FIG. 4C depicts a fifth engineering drawing 410, a sixth engineering drawing 412 and a seventh engineering drawing 414. Furthermore, FIG. 4D depicts an eighth engineering drawing 416 and a ninth engineering drawing 418. The one or more engineering drawings are provided as input to the AI-based computing system 104 for recognition of the dimensional information within the one or more engineering drawings. In an embodiment of the present disclosure, the one or more engineering drawings include the one or more objects ‘O’. Further, each of the one or more objects ‘O’ include one or more measurements, such as minimum inner diameter, maximum outer diameter, maximum length, inner radius, outer radius of each of the one or more objects within the one or more engineering diagrams and the like.

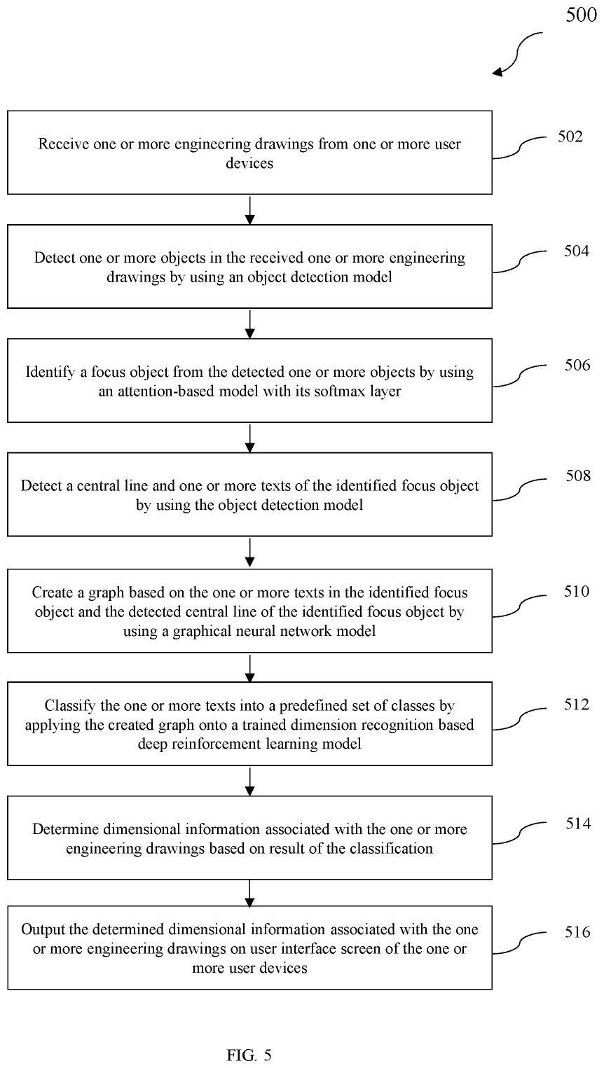

FIG. 5 is a process flow diagram illustrating an exemplary Artificial Intelligence (AI) based method for recognition of the dimensional information within the engineering drawings, in accordance with an embodiment of the present disclosure. At step 502, one or more engineering drawings 230 are received from one or more user devices 102. In an embodiment of the present disclosure, the one or more engineering drawings 230 include images, Portable Document Format (PDF), handwritten papers, scanned documents and the like. For example, the one or more engineering drawings 230 may be complex scanned engineering drawings of oil and gas parts. In an exemplary embodiment of the present disclosure, the one or more user devices 102 may include a laptop computer, desktop computer, tablet computer, smartphone, wearable device, smart watch, a digital camera and the like.

At step 504, one or more objects O1, O2 . . . Oi are detected in the received one or more engineering drawings 230 by using object detection model 232. For the sake of present description, the one or more objects O1, O2 . . . Oi have been represented as ‘O’. For example, the object detection model 232 may be YOLO V3. In an embodiment of the present disclosure, the one or more objects ‘O’ in the one or more engineering drawings 230 may represent multiple views of a single product. Therefore, it is important to identify a view from the multiple views and set boundaries where one or more required measurements are present. In an embodiment of the present disclosure, the object detection model 232 is applied on the one or more engineering drawings 230 to detect the one or more objects ‘O’ in the one or more engineering drawings 230. The object detection model 232 is a pretrained model for detecting the one or more objects ‘O’. In an embodiment of the present disclosure, the object detection model 232 detects all available engineering diagrams in the one or more engineering drawings 230 as individual objects.

At step 506, a focus object Fᵢ is identified from the detected one or more objects ‘O’ by using an attention-based model 234 with its softmax layer 236. The attention-based model 234 corresponds to “attention is all you need” mechanism. This mechanism employs similar pixels in training and prediction ignoring dissimilar pixels. In an embodiment of the present disclosure, attention function is computed on a set of queries simultaneously, packed together into a matrix Q. The keys and values are also packed together into matrices K and V. Further, matrix of outputs is computed as:

Attention(Q,K,V)=softmax(Transpose(QK)/√dk)V equation (14)

In an embodiment of the present disclosure, the focus object is an engineering drawing including one or more required measurements. In an embodiment of the present disclosure, the attention-based model 234 is location-based attention layer. In an exemplary embodiment of the present disclosure, the one or more required measurements include minimum inner diameter, maximum outer diameter, maximum length, inner radius, outer radius of each of the one or more objects within the one or more engineering diagrams and the like. In an embodiment of the present disclosure, the attention-based model 234 is applied on the detected one or more objects ‘O’ to compute one or more focus vectors f₁, f₂ . . . fₙ including a weight ‘aᵢ’ for each object in the detected one or more objects ‘O’, representing importance of each of the one or more objects ‘O’. For the sake of present description, the one or more focus vectors f₁, f₂ . . . fₙ have been represented as f. Further, the softmax layer 236 is applied on the one or more focus vectors ‘f’ to identify the focus object ‘Fᵢ’ In an embodiment of the present disclosure, the focus object ‘Fᵢ’ is computed as:

Focus object (Fi)=Σweight (ai) one or more objects (O) equation (15)

At step 508, a central line ‘Cᵢ’ and one or more texts of the identified focus object ‘Fᵢ’ is detected by using the object detection model 232. In detecting the central line ‘Cᵢ’ of the identified focus object ‘Fᵢ’ by using the object detection model 232, the AI-based method 500 includes detecting a plurality of lines from the identified focus object ‘Fᵢ’ by using the object detection model 232. In an exemplary embodiment of the present disclosure, the plurality of lines include vertical lines, central lines, horizontal lines and the like. Further, the AI-based method 500 includes determining a set of central lines L₁, L₂ . . . Lₙ among the detected plurality of lines based on prestored line information defined within the object detection model 232. For the sake of present description, the set of central lines L₁, L₂ . . . Lₙ have been represented as ‘L’. The AI-based method 500 includes identifying the central line ‘Cᵢ’ from the determined set of central lines by using the attention-based model 234 with its softmax layer 236. In an embodiment of the present disclosure, the object detection model 232 is applied on the focus object ‘Fᵢ’ to determine the set of central lines ‘L’ or detect the central line ‘Cᵢ’. Furthermore, the attention-based model 234 and the softmax layer 236 is applied on the set of central lines ‘L’ to identify a single central line ‘Cᵢ’. In an embodiment of the present disclosure, there is only a single central line ‘Cᵢ’ in a single view. Thus, the single central line ‘Cᵢ’ is identified from the set of lines ‘L’. In an embodiment of the present disclosure, the attention-based model 234 is an attention based focus vector.

At step 510, a graph is created based on the one or more texts in the identified focus object ‘Fᵢ’ and the detected central line ‘Cᵢ’ of the identified focus object ‘Fᵢ’ by using the graphical neural network model. In an embodiment of the present disclosure, the detected central line ‘Cᵢ’ is a root node and the one or more texts are one or more child nodes. In an embodiment of the present disclosure, each of the one or more child nodes and the root node has a normalized distance. The normalized distance between each of the one or more child nodes and the root node are a set of edges of the created graph. The normalized distance between each of the one or more child nodes and the root node includes the root node, the one or more child nodes and weight associated with the normalized distance. In an embodiment of the present disclosure, a function ‘Mij’ is used to compute the normalized distance between each of the one or more child nodes and the root node. In an exemplary embodiment of the present disclosure, the equation to compute the function Mij is:

Mij=fc(Euclidean distance(ni,nj),w) equation (16)

In an embodiment of the present disclosure, ‘ni’ and ‘nj’ are the root node and the one or more child nodes respectively and w is the weight associated with the one or more child nodes. Further, aggregating the node level ‘Mij’ after updating state from a trained dimension recognition based deep reinforcement learning model mat act as its average weight. Further, the created graph represents information associated with the one or more texts and relative information of the one or more texts with the central line ‘Cᵢ’. In an embodiment of the present disclosure, each of the one or more child nodes includes numerical representation of the one or more texts, location of the one or more texts and the predefined set of classes multiplied by one or more weights of the predefined set of classes. For example, a child node includes [e1, e2, e3, e4 . . . en, xmin, ymin, xmax, ymax, c₁w₁, c₂w₂, c₃w₃], where e1, e2, e3, e4 . . . en are numerical representation of the one or more texts, xmin, ymin, xmax and ymax are location of the one or more texts and c₁w₁, c₂w₂, c₃w₃ are the predefined set of classes multiplied by one or more weights of the predefined set of classes. In an embodiment of the present disclosure, the weight ‘w’ in the function ‘Mij’ determines if a child node from the one or more child nodes is useful and weights w1, w2 and w3 in the one or more child nodes determine classes of the one or more child nodes. For example, when a graph include a root node nO (Cᵢ), five child nodes n1, n2, n3, n4 and n5 and five edges MO1, MO2, MO3, MO4 and MO, first child node ‘n1’ includes [e1, e2, xmin, xmax, ymin, ymax, c₁w₁, c₂w₂] and first edge MO1 may be represented as:

MO1=fc(Euclidean distance(n0,n1),w) equation (17)

Further, second child node ‘n2’ includes [e1, e2, xmin, xmax, ymin, ymax, c₁w₁, c₂w₂] and second edge MO2 may be represented as:

MO2=fc(Euclidean distance(n0,n2),w) equation (18)

Furthermore, third child node ‘n3’ includes [e1, e2, xmin, xmax, ymin, ymax, c₁w₁] and third edge MO3 may be represented as:

MO3=fc(Euclidean distance(n0,n3),w) equation (19)

Further, fourth child node ‘n4’ includes [e1, e2, xmin, xmax, ymin, ymax, c₁w₁] and fourth edge MO4 may be represented as:

MO4=fc(Euclidean distance(n0,n4),w) equation (20)

Similarly, fifth child node ‘n5’ includes [e1, e2, xmin, xmax, ymin, ymax, c₁w₁, c₂w₂] and fifth edge MO5 may be represented as:

MO5=fc(Euclidean distance(n0,n5),w) equation (21)

Further, in creating the graph based on the one or more texts in the identified focus object ‘Fᵢ’ and the detected central line ‘Cᵢ’ of the identified focus object ‘Fᵢ’ by using the graphical neural network model, the AI-based method 500 includes computing hidden state of each of the one or more child nodes by computing average of one or more feature vectors from one or more neighboring nodes 238. In an embodiment of the present disclosure, the Graph Convolutional Network (GCN) is used to leverage graph adjacency information. Furthermore, the AI-based method 500 includes combining plurality of GCN layers together based on the computed hidden state of each of the one or more child nodes. The AI-based method 500 includes receiving centerline information associated with the central line ‘Cᵢ’ and adjacent field information by each of the one or more child node from one or more farther child nodes by using the combined plurality of GCN layers. In an embodiment of the present disclosure, the one or more farther child nodes are farther from respective node. For example, if there are 4 nodes, the relative distance from each other can also be leveraged. Further, the AI-based method 500 includes transmitting the centerline information and the adjacent field information to one or more last GCN layers by using the combined plurality of GCN layers. In an exemplary embodiment of the present disclosure, transmission of the centerline information and the adjacent field information to one or more last GCN layers is performed by using five GCN layers. In an embodiment of the present disclosure, the GCN layer may be formulated as:

H(l+1)=σ(D−½AD−½)H(l)W(l) equation (22)

A=A˜+IN equation (23)

In an embodiment of the present disclosure, A is adjacency matrix (A^{˜}) of topology graph G plus identity matrix (I_{N}). In an embodiment of the present disclosure, adding the identity matrix (I_{N}) is common in GCN networks. In an embodiment of the present disclosure, a GCN layer computes mean of one or more neighbor child node's feature vectors 238. Further, a set of aggregated feature nodes 240 are obtained from result of aggregation. In an embodiment of the present disclosure, five GCN layers are used for calculation of hidden state of each node.

Dii=ΣjAij equation (24)

In an embodiment of the present disclosure, Dᵢᵢ and W^{l} is a layer-specific trainable weight matrix, echoing with the shared weights. Further, σ(·) is an activation function such as:

eLU(·)·H(l)∈Rn×d equation (25)

In an embodiment of the present disclosure ReLU(·) is the hidden features in the lth layer (n: number of nodes, d: feature dimension).

H0=S equation (26)

In an embodiment of the present disclosure, H⁰ are the input state vectors for actor. In an embodiment of the present disclosure, averaging and smoothing across the one or more child nodes is done to minimize ‘L2’ error.

In an embodiment of the present disclosure, when the focus object ‘Fᵢ’ is identified, the one or more required measurements are drawn relative to the detected central line ‘Cᵢ’. Further, it is important to retain relative information between the one or more required measurements and the central line ‘Cᵢ’. Thus, the object detection model 232 is used to detect the central line ‘Cᵢ’ and the graphical neural network model is used to establish and leverage the relative information where the detected central line ‘Cᵢ’ acts as the root node and the one or more texts act as the one or more child nodes.

At step 512, the one or more texts are classified into a predefined set of classes by applying the created graph onto a trained dimension recognition based deep reinforcement learning model. In classifying the one or more texts into the predefined set of classes by applying the created graph onto the trained dimension recognition based deep reinforcement learning model, the AI-based method 500 includes updating weights of each of the one or more child nodes and the set of edges by using the trained dimension recognition based deep reinforcement learning model. Further, the AI-based method 500 includes classifying the one or more texts into the predefined set of classes based on the updated weights of each of the one or more child nodes by using the trained dimension recognition based deep reinforcement learning model. In an embodiment of the present disclosure, the trained dimension recognition based deep reinforcement learning model includes one or more components including environment, state, actions and reward. In an embodiment of the present disclosure, the environment includes the graph with the root node, the one or more child nodes and weights associated with the set of edges. Further, the state describes class label at each of the one or more child nodes. The actions include selecting one class, such as ‘C_{u,k}’ in each of the one or more child nodes and changing the selected class to a value near 0 or 1. In an exemplary embodiment of the present disclosure, changing the selected class to a value near 0 or 1 results in 3*m actions where m is number of the set of predefined classes. In an embodiment of the present disclosure, the trained dimension recognition based deep reinforcement learning model may assign the value of class ‘C_{u,k}’ between 0.9 to 1.0, such that the class ‘C_{u,k}’ may be multiplied by a classifier's weight. The output of the multiplication may be the classifier's weight. Therefore, the value of class ‘C_{u,k}’ gets high importance to the classifier. In an embodiment of the present disclosure, the trained dimension recognition based deep reinforcement learning model may also assign the value of ‘C_{u,k}’ between 0 to 0.01. In this scenario, the class ‘C_{u,k}’ is neutral and unimportant to a classifier as it will result in 0 when multiplied by the classifier's weight. In an embodiment of the present disclosure, in parallel at each action, a weight is also assigned to the function ‘Mij’ which will result in the usefulness of child node. Further, the reward is given based on how successful the class of each of the one or more child nodes is predicted by the trained dimension recognition based deep reinforcement learning model. In an embodiment of the present disclosure, negative reward is −1 and positive reward may be 1. The total reward of the trained dimension recognition based deep reinforcement learning model is sum of each node predictions. In an embodiment of the present disclosure, the trained dimension recognition based deep reinforcement learning model may perform actions by selecting one class in each of the one or more child nodes. In an embodiment of the present disclosure, environment 242 includes a feature vector 244 upon which an action is performed, and feedback is calculated. At block 246, feedback is computed. Further, agent 248 is a small neural network whose output are actions 250 required to be taken on the environment 242.

At step 514, dimensional information associated with the one or more engineering drawings 230 is determined based on result of the classification. In determining the dimensional information associated with the one or more engineering drawings 230 based on result of the classification, the AI-based method 500 includes determining the set of child nodes from the one or more child nodes based on the updated weights of each of the set of edges by using the trained dimension recognition based deep reinforcement learning model. Further, the AI-based method 500 includes determining the dimensional information associated with the one or more engineering drawings 230 based on classification of the one or more texts into the predefined set of classes and the determined set of child nodes by using the trained dimension recognition based deep reinforcement learning model. In an exemplary embodiment of the present disclosure, the dimensional information include minimum inner diameter, maximum outer diameter, maximum length, inner radius, outer radius of each of the one or more objects within the one or more engineering diagrams and the like.

In an embodiment of the present disclosure, before using the trained dimension recognition based deep reinforcement learning model, dimension recognition based deep reinforcement learning model is required to be trained. In training the dimension recognition based deep reinforcement learning model, the AI-based method 500 includes correlating the focus object ‘Fᵢ’, the central line ‘Cᵢ’ of the focus object ‘Fᵢ’ and the one or more texts in the focus object Fᵢ. Further, the AI-based method 500 includes training the dimension recognition based deep reinforcement learning model based on result of correlation.

At step 516, the determined dimensional information associated with the one or more engineering drawings 230 is outputted on user interface screen of the one or more user devices 102.

The AI-based method 500 may be implemented in any suitable hardware, software, firmware, or combination thereof.

Thus, various embodiments of the present AI-based computing system 104 provide a solution to recognize the dimensional information within the engineering drawings. The AI-based computing system 104 uses a multi-modal architecture which is a combination of computer vision with graph-based reinforcement learning techniques to recognize dimensional data within complex scanned engineering drawings. This contrasts with conventional approaches which use mostly computer vision and NLP techniques for the same purpose. Thus, the AI-based computing system 104 is more accurate as compared to the conventional approaches. The AI-based computing system 104 closely mimics how a human brain would read and interpret the one or more engineering drawings and it is able to work on complex drawings with higher accuracy. Further, the AI-based computing system 104 focuses on the one or more required measurements driven by the central line ‘Cᵢ’ of the focus object ‘Fᵢ’. Since there are multiple views of a single product on a page, the AI-based computing system 104 identifies a view and set the boundaries where the required measurements are present. In an embodiment of the present disclosure, the AI-based computing system 104 identifies the one or more required measurements using the relative information from the central line ‘Cᵢ’. Furthermore, the AI-based computing system 104 detect correct classes of each of the one or more child nodes. The AI-based computing system 104 presents transfer learnt object detection model 232, two attention models and a Reinforcement Learning (RL)-GCN model benefitting the visual and the textual feature vectors. In an embodiment of the present disclosure, GCN is used to leverage the adjacency information into the RL agent. The AI-based computing system 104 uses computer vision and graph based deep reinforcement learning agents to learn to distinguish different data on the one or more engineering drawings and extract the dimensional data. Further, the AI-based computing system 104 solves the problem of manually reading the scanned engineering drawings and extracting relevant dimensions for quality checking of manufactured parts. In an embodiment of the present disclosure, the trained dimension recognition based deep reinforcement learning model is trained to get the class of the individual node to distinguish required dimensions from all other dimensions present on the one or more engineering drawings 230. Furthermore, the AI-based computing system 104 automatically extract dimensions and tolerances from the scanned engineering drawings that may be fed into the CMM (Coordinate measurement machines) for quality inspection of manufactured parts. Further, the extracted dimensions and tolerances from the scanned engineering drawings may also be sent to a database for reporting purposes.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. An Artificial Intelligence (AI)-based computing system for recognition of dimensional information within engineering drawings, the AI-based computing system comprising:
one or more hardware processors; and
a memory coupled to the one or more hardware processors, wherein the memory comprises a plurality of modules in the form of programmable instructions executable by the one or more virtualized hardware processors, wherein the plurality of modules are inside an edge server, wherein the plurality of modules comprises:
a data receiver module configured to receive one or more engineering drawings from one or more user devices, wherein the one or more engineering drawings comprise: images, Portable Document Format (PDF), handwritten papers and scanned documents;
an object detection module configured to detect one or more objects in the received one or more engineering drawings by using an object detection model;
an object identification module configured to identify a focus object from the detected one or more objects by using an attention-based model with its softmax layer, wherein the focus object is an engineering drawing comprising one or more required measurements;
a line detection module configured to detect a central line and one or more texts of the identified focus object by using the object detection model;
a graph creation module configured to create a graph based on the one or more texts in the identified focus object and the detected central line of the identified focus object by using a graphical neural network model, wherein the detected central line is a root node and the one or more texts are one or more child nodes, wherein each of the one or more child nodes and the root node has a normalized distance, wherein the normalized distance between each of the one or more child nodes and the root node are a set of edges of the created graph, and wherein the created graph represents information associated with the one or more texts and relative information of the one or more texts with the central line;
a text classifying module configured to classify the one or more texts into a predefined set of classes by applying the created graph onto a trained dimension recognition based deep reinforcement learning model;
a dimensional information determination module configured to determine dimensional information associated with the one or more engineering drawings based on result of the classification; and
a data output module configured to output the determined dimensional information associated with the one or more engineering drawings on user interface screen of the one or more user devices.

2. The AI-based computing system of claim 1, wherein the one or more required measurements comprise: minimum inner diameter, maximum outer diameter, maximum length, inner radius and outer radius of each of the one or more objects within the one or more engineering diagrams.

3. The AI-based computing system of claim 1, wherein in detecting the central line and the one or more texts of the identified focus object by using the object detection model, the line detection module is configured to:
detect a plurality of lines from the identified focus object by using the object detection model, wherein the plurality of lines comprises vertical lines, central lines and horizontal lines;
determine a set of central lines among the detected plurality of lines based on prestored line information defined within the object detection model; and
identify the central line from the determined set of central lines by using the attention-based model with its softmax layer.

4. The AI-based computing system of claim 1, wherein in classifying the one or more texts into the predefined set of classes by applying the created graph onto the trained dimension recognition based deep reinforcement learning model, the text classifying module is configured to:
update weights of each of the one or more child nodes and the set of edges by using the trained dimension recognition based deep reinforcement learning model; and
classify the one or more texts into the predefined set of classes based on the updated weights of each of the one or more child nodes by using the trained dimension recognition based deep reinforcement learning model.

5. The AI-based computing system of claim 4, wherein in determining the dimensional information associated with the one or more engineering drawings based on result of the classification, the dimensional information determination module is configured to:
determine a set of child nodes from the one or more child nodes based on the updated weights of each of the set of edges by using the trained dimension recognition based deep reinforcement learning model; and
determine the dimensional information associated with the one or more engineering drawings based on classification of the one or more texts into the predefined set of classes and the determined set of child nodes by using the trained dimension recognition based deep reinforcement learning model.

6. The AI-based computing system of claim 1, further comprises a model training module configured to train a dimension recognition based deep reinforcement learning model, wherein in training the dimension recognition based deep reinforcement learning model, the model training module is configured to:
correlate the focus object, the central line of the focus object and the one or more texts in the focus object; and
train the dimension recognition based deep reinforcement learning model based on result of correlation.

7. The AI-based computing system of claim 1, wherein each of the one or more child nodes comprises: numerical representation of the one or more texts, location of the one or more texts and the predefined set of classes multiplied by one or more weights of the predefined set of classes.

8. The AI-based computing system of claim 1, wherein in creating the graph based on the one or more texts in the identified focus object and the detected central line of the identified focus object by using the graphical neural network model, the graph creation module is configured to:
compute a hidden state of each of the one or more child nodes by computing average of one or more feature vectors from one or more neighboring nodes;
combine plurality of Graph Convolutional Network (GCN) layers together based on the computed hidden state of each of the one or more child nodes;
receive centerline information associated with the central line and adjacent field information by each of the one or more child node from one or more farther child nodes by using the combined plurality of GCN layers; and
transmit the centerline information and the adjacent field information to one or more GCN last layers by using the combined plurality of GCN layers.

9. The computing system of claim 8, wherein transmission of the centerline information and the adjacent field information to one or more last GCN layers is performed by using five Graph Convolutional Network (GCN) layers.

10. The AI-based computing system of claim 1, wherein the normalized distance between each of the one or more child nodes and the root node comprises the root node, the one or more child nodes, and weight associated with the normalized distance.

11. An Artificial Intelligence (AI)-based method for recognition of dimensional information within engineering drawings, the AI-based method comprising:
receiving, by one or more hardware processors, one or more engineering drawings from one or more user devices, wherein the one or more engineering drawings comprise: images, Portable Document Format (PDF), handwritten papers and scanned documents;
detecting, by the one or more hardware processors, one or more objects in the received one or more engineering drawings by using an object detection model;
identifying, by the one or more hardware processors, a focus object from the detected one or more objects by using an attention-based model with its softmax layer, wherein the focus object is an engineering drawing comprising one or more required measurements;
detecting, by the one or more hardware processors, a central line and one or more texts of the identified focus object by using the object detection model;
creating, by the one or more hardware processors, a graph based on one or more texts in the identified focus object and the detected central line of the identified focus object by using a graphical neural network model, wherein the detected central line is a root node and the one or more texts are one or more child nodes, wherein each of the one or more child nodes and the root node has a normalized distance, wherein the normalized distance between each of the one or more child nodes and the root node are a set of edges of the created graph, wherein the created graph represents information associated with the one or more texts and relative information of the one or more texts with the central line;
classifying, by the one or more hardware processors, the one or more texts into a predefined set of classes by applying the created graph onto a trained dimension recognition based deep reinforcement learning model;
determining, by the one or more hardware processors, dimensional information associated with the one or more engineering drawings based on result of the classification; and
outputting, by the one or more hardware processors, the determined dimensional information associated with the one or more engineering drawings on user interface screen of the one or more user devices.

12. The AI-based method of claim 11, wherein the one or more required measurements comprise: minimum inner diameter, maximum outer diameter, maximum length, inner radius and outer radius of each of the one or more objects within the one or more engineering diagrams.

13. The AI-based method of claim 11, wherein detecting the central line and the one or more texts of the identified focus object by using the object detection model comprises:
detecting a plurality of lines from the identified focus object by using the object detection model wherein the plurality of lines comprises vertical lines, central lines, and horizontal lines;
determining a set of central lines among the detected plurality of lines based on prestored line information defined within the object detection model; and
identifying the central line from the determined set of central lines by using the attention-based model with its softmax layer.

14. The AI-based method of claim 11, wherein classifying the one or more texts into the predefined set of classes by applying the created graph onto the trained dimension recognition based deep reinforcement learning model comprises:
updating weights of each of the one or more child nodes and the set of edges by using the trained dimension recognition based deep reinforcement learning model; and
classifying the one or more texts into the predefined set of classes based on the updated weights of each of the one or more child nodes by using the trained dimension recognition based deep reinforcement learning model.

15. The AI-based method of claim 14, wherein determining the dimensional information associated with the one or more engineering drawings based on result of the classification comprise:
determining a set of child nodes from the one or more child nodes based on the updated weights of each of the set of edges by using the trained dimension recognition based deep reinforcement learning model; and
determining the dimensional information associated with the one or more engineering drawings based on classification of the one or more texts into the predefined set of classes and the determined set of child nodes by using the trained dimension recognition based deep reinforcement learning model.

16. The AI-based method of claim 11, further comprises training a dimension recognition based deep reinforcement learning model, wherein training the dimension recognition based deep reinforcement learning model comprises:
correlating the focus object, the central line of the focus object and the one or more texts in the focus object; and
training the dimension recognition based deep reinforcement learning model based on result of correlation.

17. The AI-based method of claim 11, wherein each of the one or more child nodes comprises: numerical representation of the one or more texts, location of the one or more texts and the predefined set of classes multiplied by one or more weights of the predefined set of classes.

18. The AI-based method of claim 11, wherein creating the graph based on the one or more texts in the identified focus object and the detected central line of the identified focus object by using the graphical neural network model comprises:
computing hidden state of each of the one or more child nodes by computing average of one or more feature vectors from one or more neighboring nodes;
combining plurality of Graph Convolutional Network (GCN) layers together based on the computed hidden state of each of the one or more child nodes;
receiving centerline information associated with the central line and adjacent field information by each of the one or more child node from one or more farther child nodes by using the combined plurality of GCN layers; and
transmitting the centerline information and the adjacent field information to one or more last GCN layers by using the combined plurality of GCN layers.

19. The method of claim 18, wherein transmission of the centerline information and the adjacent field information to one or more last GCN layers is performed by using five Graph Convolutional Network (GCN) layers.

20. The AI-based method of claim 11, wherein the normalized distance between each of the one or more child nodes and the root node comprises: the root node, the one or more child nodes and weight associated with the normalized distance.
